(19) United States
(12) Patent Application Publication
(10) Pub. No.: US 2020/0269434 A1
(43) Pub. Date: Aug. 27, 2020

(54) JAWLESS GRIPPER ENHANCED ROBOTIC KITCHEN SYSTEM FOR FOOD ASSEMBLY

(71) Applicant: Miso Robotics, Inc., Pasadena, CA (US)

(72) Inventors: Robert Anderson, Pasadena, CA (US); William Werst, Pasadena, CA (US); David Zito, Pasadena, CA (US)

(21) Appl. No.: 16/801,525

(22) Filed: Feb. 26, 2020

Related U.S. Application Data
(60) Provisional application No. 62/810,936, filed on Feb. 26, 2019.
(60) Provisional application No. 62/810,947, filed on Feb. 26, 2019.

(51) Int. Cl. B25J 11/00; B25J 9/00; B25J 9/16; B25J 15/06; B65G 15/00; B65G 47/46; A47J 44/00

(52) U.S. Cl. CPC B25J 11/0045; B25J 9/0093; B25J 9/1697; B25J 9/163; B65G 2201/0202; B25J 15/0633; B65G 15/00; B65G 47/46; A47J 44/00; B25J 15/0675

(57) ABSTRACT

A robotic food singulation system for providing individual food units in a predetermined arrangement from a whole raw food. A food preparation device outputs individual food units, one at a time, onto a conveyor belt. A programmed processor computes an identity score for the food unit, and evaluates a singulation quality based on characteristics from various sensors or cameras aimed at the conveyor and food unit. The system instructs a robotic arm to pick up the food unit and distribute it in a predetermined arrangement on a target substrate, optionally, with a jawless gripping and release assembly. The target substrate may be a storage device or another food item itself depending on the food assembly instructions. Related methods are also described.

### CROSS-REFERENCE TO RELATED APPLICATIONS

This claims priority to provisional application No. 62/810,936, filed Feb. 26, 2019, and provisional application No. 62/810,947, filed Feb. 26, 2019, each of which is incorporated herein in its entirety for all purposes.

### BACKGROUND OF THE INVENTION

### 1. Field of the Invention

This invention relates to kitchen appliances and more particularly to robotic kitchen apparatuses for automatic food preparation in a restaurant kitchen environment.

### 2. Description of the Related Art

There are a number of challenges associated with automatic food preparation in a restaurant or commercial kitchen not the least of which is ‘singulating’ food items from raw whole food. ‘Singulating’ food items is important in automated food preparation because many assembled food items (e.g., pizzas, sandwiches, etc.) require individual items (e.g., slices of meat) to be freshly created, and placed individually in a distributed fashion. However, these types of food items tend to stick to each other and are difficult, if not practically impossible, to ‘singulate.’

Additionally, in many instances, creating the individual food items requires slicing. Slicing requires large machines for hard food such as a pepperoni stick, and the slices simply fall from the blade area, forming a pile of ‘stuck together’ food items.

Although conventional robotic assemblies can pick and place many non-food items, the conventional robotic assemblies do not singulate food items that stick to each other (e.g., cheese slices, sliced deli-meats, pepperoni slices, etc.). Sticky food items also tend to adhere to the robot equipment itself. This is undesirable.

What is needed is an improved system and method that overcomes the above-mentioned shortcomings and that can fit in a small commercial kitchen environment.

Additionally, an improved system and method capable of picking up a sticky food item, and having a food removal or release action to accurately deposit the item is needed.

Accordingly, a robotic kitchen singulation system that overcomes the above-mentioned challenges is desirable.

### SUMMARY OF THE INVENTION

A robotic food singulation system for preparing individual food units from a raw food comprises a conveyor system comprising a conveyor belt; a food preparation device arranged above the conveyor belt and adapted to accept the raw food and output a plurality of food units, one food unit at a time, onto the conveyor belt; at least one sensor or camera aimed at the conveyor belt; and a robotic arm adapted to pick up the food units, one at a time, from the conveyor and place the food units, one at a time, on a target substrate. Optionally, the robotic arm is enhanced with a jawless gripper to pick up and deposit the food item.

In embodiments, the robotic food singulation system further includes a computer or workstation having one or more memory devices, processors, and controllers. The memory preferably has a library of multiple patterns or arrangements for the food items on a target substrate. The processor is operable to determine each food unit on the conveyor belt; determine an identity score for the food unit on the conveyor belt; evaluate singulation quality of the food item based on a plurality of characteristics of the food unit while on the conveyor belt; compute a pickup location of the food unit for pickup; instruct the robotic arm to pick up the food unit; and instruct the robotic arm to place the food unit on a target substrate according to one of said arrangements or patterns from the memory device.

In embodiments, a food preparation method includes positioning a jawless gripping device above a food item to be picked up. The gripping device directs a gas through a flow manifold at the food item to create a small area of low static pressure between a food item and the gripping device. A pressure differential around the food item is created, resulting in the food item being lifted towards the gripping device.

In embodiments, a second jet stream of gas is directed at the food item from designated release ports to eject or remove the food item from the surface of the gripping device.

### Objects and Advantages

Various embodiments of the invention have the following objects and advantages: capability for preparing foods in coordination with other automatic kitchen equipment; capability for picking and placing sliced food items; capability for picking and placing organic and optionally sticky ingredients; capability for preparing unprocessed ingredients and loading them into a storage location that is reachable by the robotic arm for future use.

The description, objects and advantages of embodiments of the present invention will become apparent from the detailed description to follow, together with the accompanying drawings.

### BRIEF DESCRIPTION OF THE DRAWINGS

FIG. 1A is a perspective view of a robotic kitchen singulating system for creating, picking and placing individual food items in accordance with an embodiment of the invention;

FIG. 1B is a flow chart of a process for creating, picking and placing individual food items in accordance with an embodiment of the invention;

FIG. 1C is a block diagram of a system for creating, picking and placing individual food items in accordance with an embodiment of the invention;

FIG. 2 is an enlarged partial view of a jawless gripper assembly in accordance with an embodiment of the invention;

FIG. 3 top perspective view of a jawless gripper assembly in accordance with an embodiment of the invention;

FIG. 4 is a side view of the jawless gripper assembly shown in FIG. 3 with a transparent outer surface for visualizing the inner structures;

FIG. 5 is an illustration of a gas flowstream through the jawless gripper assembly shown in FIG. 4, viewed from a bottom perspective; and

FIG. 6 is an illustration of a gas flowstream through the jawless gripper assembly shown in FIG. 4.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Described herein is a robotic singulation system.

System Overview

This invention is directed to systems and methods that provide accurate manipulation of a wide range of food items, and particularly, organic and non-uniform categories of food that tend to stick to an opposing surface.

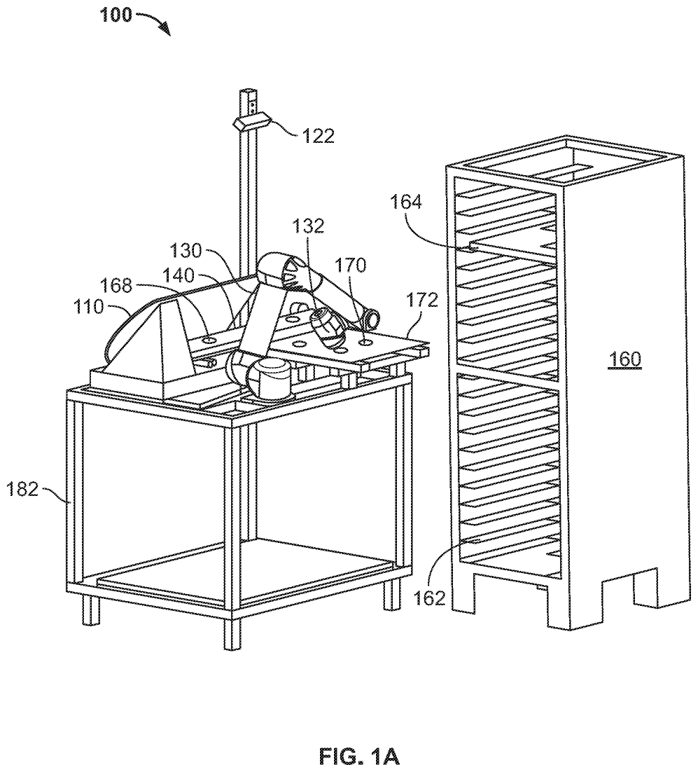

FIG. 1A shows an automated food preparation system 100 operable to singulate, evaluate quality, pick, and release food items 170 (e.g., slices of meat) onto a substrate 172 (e.g., a tray or pizza dough) in a specific arrangement or pattern. The system 100 is shown having a deli meat slicer 110, a conveyor system 140 configured to fit underneath the slicer, one or more cameras and sensors 122 aimed at the workspace, a robotic arm 130, end effector 132, and a processor (not shown) operable to manage the robotic arm and other operations of the system as described herein. Non-limiting examples of robotic arms, sensors, and programmed processors for scheduling, image processing, object recognition, and controlling the components are described in, e.g., U.S. Patent Publication No. 20180345485, filed Aug. 10, 2018, and entitled “MULTI-SENSOR ARRAY INCLUDING AN IR CAMERA AS PART OF AN AUTOMATED KITCHEN ASSISTANT SYSTEM FOR RECOGNIZING AND PREPARING FOOD AND RELATED METHODS”, incorporated herein by reference in its entirety for all purposes.

The components of the system 100 are shown mounted on frame 182 and collectively occupy a small footprint, allowing the system to be installed in small kitchen environments.

FIG. 1A also shows storage unit 160 adapted to hold trays or dishes 164. The storage unit is within reach of the robotic arm 130. The robotic arm 130 can insert or withdraw the trays 164 for later use.

Singulation Method

With reference to FIGS. 1A, 1B and 1C, a method flow chart 200 and system block diagram 260 are shown for singulating individual food items from a raw whole food in a small kitchen footprint.

Step 210 states food prep. This food preparation step involves placing or inserting the raw food into a food preparation apparatus. Examples of food preparation apparatus' or appliances 262 include without limitation deli meat slicers, meat extruders, vegetable peelers, food processors or other food preparation devices.

The food can be transferred to the food preparation device using a robotic arm 130, 264, in combination with an end effector 132, 266. Examples of suitable end-effectors include, soft robotics grippers and in preferred embodiments, jawless grippers as described herein.

Step 220 states singulation. In embodiments, and with reference also to FIG. 1A, the now prepped food (e.g., 168) is output (namely, falls) onto a moving food-safe conveyor belt 140, 263 one item at a time. The system prevents food from stacking up.

The now-prepared food 168 travels by the conveyor belt as an individual or singulated item. This singulation step is important for it increases the speed and accuracy of object recognition of the food items, improving the food preparation process.

Step 230 states detection. In embodiments, a sensor (e.g., 122, 268) quickly obtains data (e.g., image frames) of the singulated food item. Examples of types of sensors include without limitation RGB, IR, and/or Depth types of sensors. The sensor, in combination with a programmed processor 284, will run a food item detection and recognition module 285 using a trained classifier to identify the food item. Optionally, a score or probability is assigned to the likelihood the food item is correctly classified.

Step 240 states evaluation. In this step, a quality singulation module 274 or engine assesses the quality of the identified food item. In embodiments, a classifier is trained on singulated food items on the conveyor in transit. In embodiments, the system excludes the singulated food item based on a threshold value of quality or metric. The quality can be a score or level that the singulated food item is acceptable. Examples of criteria or parameters to evaluate include shape, color, thickness, quantity, eccentricity, area continuity, perimeter continuity, etc.

Additionally, in embodiments, the sensor(s) and processor are operable to calculate the size, location and velocity of the food item for the robotic arm to precisely pick it up. In embodiments, a method step calibrates the system to obtain the speed of the conveyor and the location of the components relative to each other. For example, a sensor on the conveyor belt may be used to determine speed of the conveyor.

Step 250 states to pick and place. Knowing the food type and trajectory, the robotic kitchen system 100, 260 can accurately pick up the prepared food 168 and manipulate it onto another substrate 172 (optionally, place it onto a pizza, into a canister, etc.). As described further herein, in preferred embodiments, a jawless gripper assembly is adapted to pick up or collect the food item and eject it onto a target location even if the food item has a tendency to stick to the gripper. The food item may be placed in a predetermined arrangement where the process updates the system state and continues until the predetermined arrangement is complete. An exemplary arrangement of the food item is a set of evenly distributed meat slices placed on a flat round pizza dough, or a slice of cheese placed on an array of open-faced sandwiches. The computer 270 may have a library 282 of recipes and predetermined arrangements corresponding to a particular type of food item. Indeed, once the food item is singulated, a wide range of patterns and arrangements (e.g., letters, signs, figures, indicia) may be executed by the robotic arm and grippers as described herein.

Additionally, the food item itself 170 or the entire the substrate 172 may be placed in another location such as the storage unit 160, allowing the robotic kitchen assistant to access the food items later. In embodiments, the system places prepared foods into containers that can be stored for future use by the system during the cooking process.

FIG. 1C also shows a communication interface 290 which can be operable to exchange data (wireless or otherwise) between the computer and a wide range devices including, e.g., local or remote servers 292, customer kiosks 294, smart phones and tablets 296, etc.

The embodiment shown in FIG. 1C also has a user interface 298 which may include various types of devices to interface directly with the computer 270 including but not limited to a display, speaker, keyboard, touchscreen, microphone etc. The computer also should have or be connected with one or more controllers as is known to those of skill in the art to interface the processor with the various components of the system described herein.

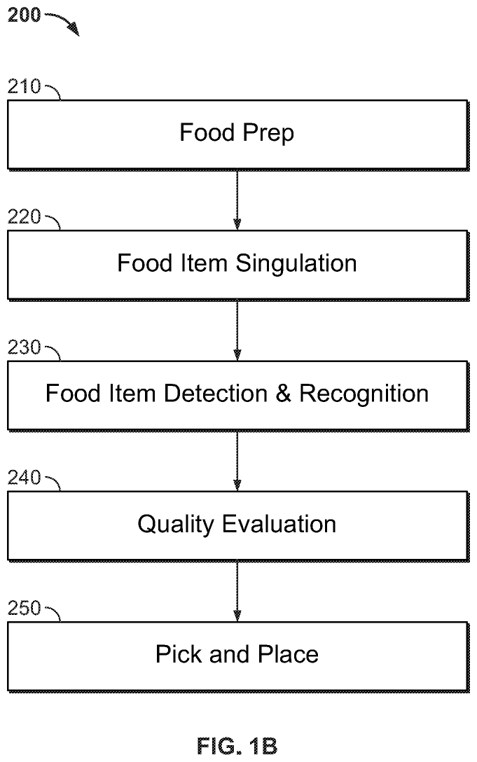

FIG. 2 shows an enlarged view of a robotic arm end portion 132 and jawless gripper assembly 300 in accordance with an embodiment of the invention for picking and releasing individual meat slices 302. Particularly, jawless gripper 300 is shown secured to end effector 394 via an adapter plate 398. An actuator 392 is operable to open and close the clamping arms 394 onto a portion of the adapter plate 398. Gas lines 396 are shown for supplying pressure and gas to the jaw less gripper 300.

Although FIG. 2 shows a specific arrangement of components to secure the jawless end effector to the robotic arm 132, the invention is not intended to be so limited. Indeed, a wide range of structures and arrangements may be employed to attach the jawless gripper to a robotic arm. An example of a clamping apparatus to hold a wide range of tools is described in US Patent Publication No. 20200047349, filed Aug. 7, 2019, and entitled “ROBOTIC KITCHEN ASSISTANT INCLUDING UNIVERSAL UTENSIL GRIPPING ASSEMBLY”, incorporated herein by reference in its entirely.

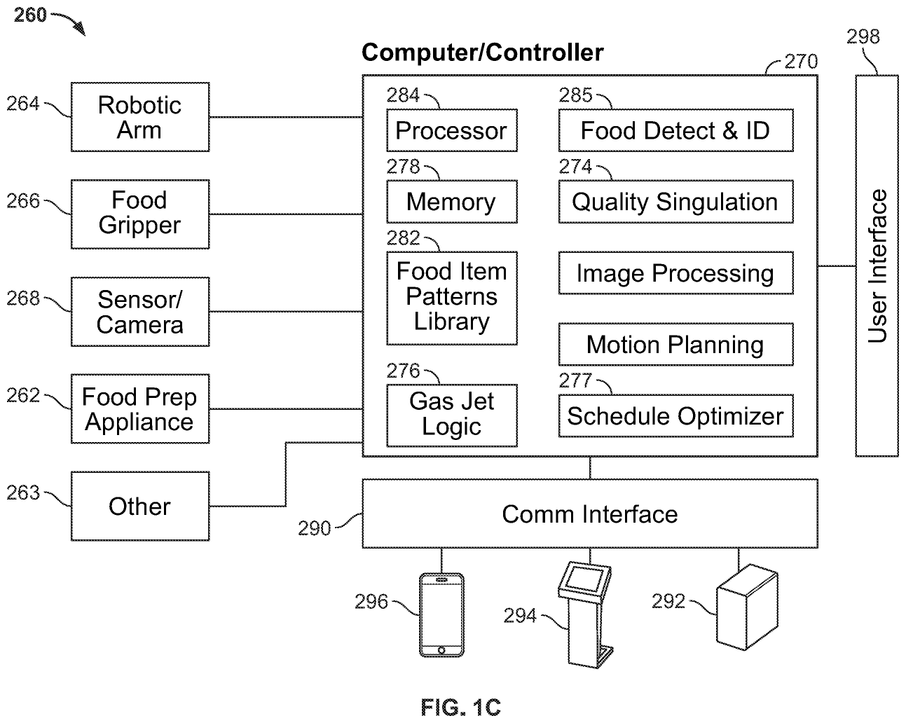

FIG. 3 is a top perspective view of a jawless gripper assembly 300 in accordance with an embodiment of the invention. The gripper assembly 300 is shown having a circular disk-shaped body 310, proximal surface 312, and independent gas stream entry ports 252, 362 described further herein. Its thickness or height may vary. In embodiments its height (h) ranges from 0.5 to 3 inches. Likewise, its outer diameter may vary. In embodiments, the outer diameter (OD) ranges from 2-8 inches.

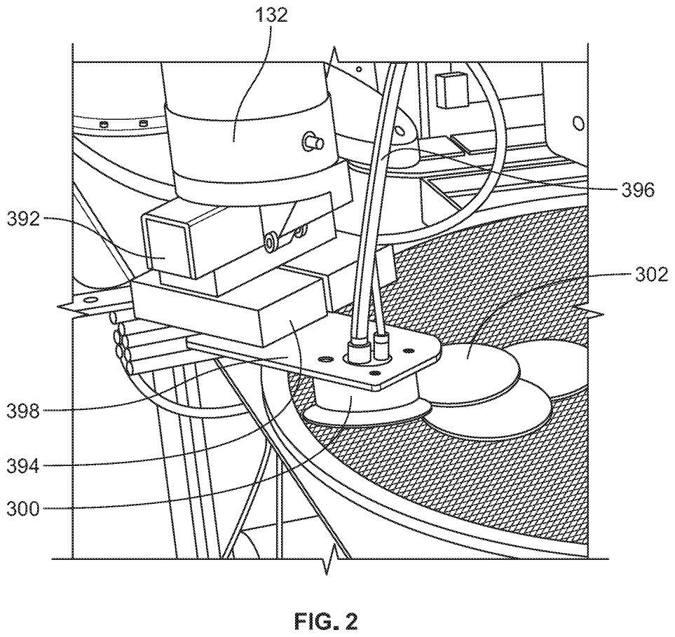

FIG. 4 is a side view of the jawless gripper assembly 300 shown in FIG. 3 with a transparent outer surface for visualizing its inner structure. As shown, the jawless gripper assembly includes a body 310 and a proximal surface 312, and a substantially planar distal surface 320. The distal surface defines a food collection area 330 for picking up a food item, and an annular shaped low pressure region 340 surrounding the food collection area. In the embodiment shown in FIG. 4, the food collection area is a shallow cavity defined by a depth (d) and concave perimeter wall 332. A non-limiting exemplary range for the depth (d) is 0.5-5 mm. Additionally, in embodiments, the food collection region 330 or cavity is sized to accommodate a food item for pickup such as a thin slice of cheese or meat having a diameter ranging from 1-6 inches. However, the invention is not so limited.

FIG. 4 also shows a first channel 354 and a second channel 364 extending through the body 310, defining a first gas flowpath and a second gas flowpath independent from the first gas flowpath. The first flowpath commences at port 352, continues through channel 354, to manifold 355, and exits at one more ports which collectively create the annular shaped low pressure region 340. Preferably, the shape and spacing between the plurality of lift ports are designed to provide a near continuous elongate ring. Additionally, in the embodiment shown in FIG. 4, the manifold 355 exits or transitions to a bell-mouth or trumpet shape port(s). The wall 342 is shown having a gentle outward curvature (namely, a convex curvature) in the direction of gas flow.

The second flowpath commences at port 362, continues through channel 364, and exits at a plurality of release or ejection ports in second region 330.

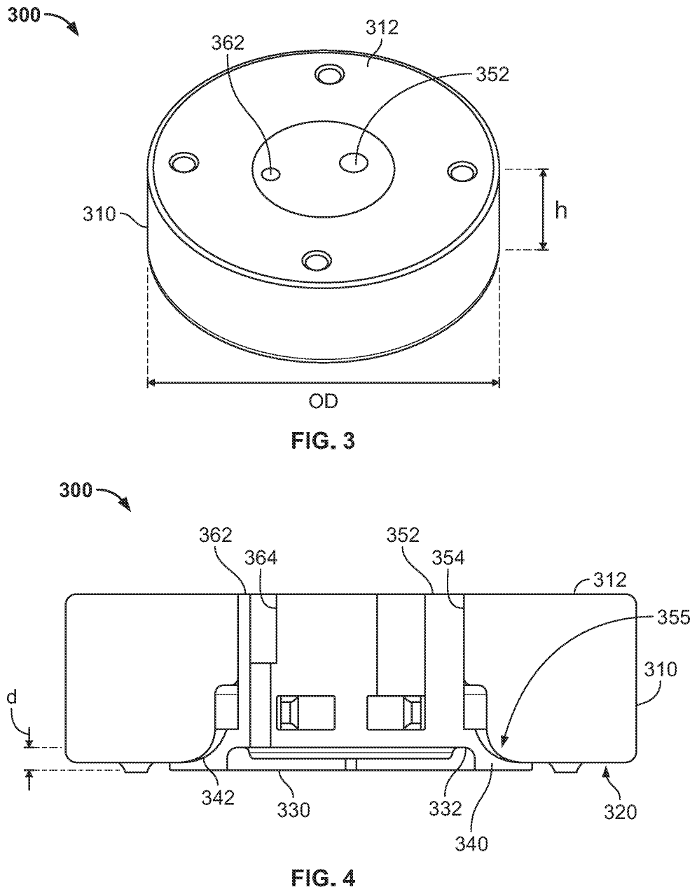

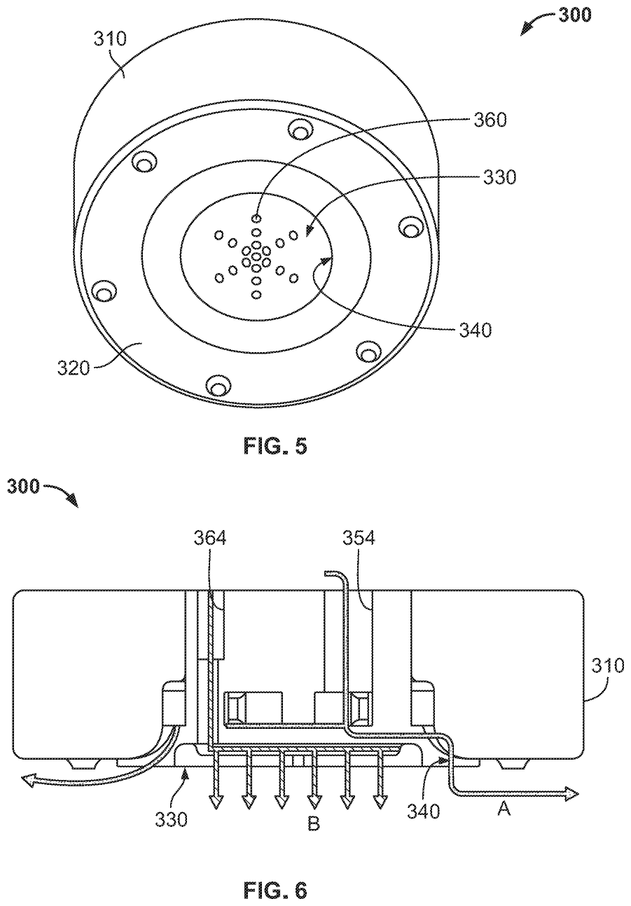

In operation, and with reference to FIGS. 5 and 6, a gas stream (A) of air or another gas is sent along the first flowpath and exits port(s) in first region 340. When a food item (not shown) is present underneath the food collection area 330, and the positive gas steam (A) is activated, a pressure difference is created across the food item lifting the food item to the distal surface 320 of the assembly 300. The food item is held in place while the gas stream (A) is activated. Without intending to being bound to theory, the pressure difference across the food item arises from the Bernoulli principle.

Once the food item is picked up, it may be positioned over a predetermined target location by the robotic arm. The jawless gripper assembly 300 can selectively eject the food item onto a target substrate such as the tray 172 shown in FIG. 1A.

To release the food item, gas stream (B) is activated and, optionally, gas stream (A) is terminated. Gas stream (B) flows from a gas source, though second flow path described above, and through ports 360, pushing the food item from the distal surface even if the food item is unduly sticky and is still adhering to distal surface 320. In embodiments, the singulating system includes a food item jet module 276 run by the computer 270 for releasing or ejecting the food item from the distal surface 320. The jet release module can include a set of instructions on a non-transient memory device 278 and readable by a processor 284 to control a valve to a pneumatic source (not shown) to (i) terminate the gas stream (A), and (ii) commence the gas stream (B) based on when the location of the robotic arm is within a threshold distance from the target 3D location for placing the (namely, ejecting) the food item on to the target substrate. In embodiments, the jet release module can be operable to commence gas stream (B) based on determining whether the food item sticks to the distal surface from image data from one or more cameras.

Although the body 310 is shown having a cylindrical or disk-like shape, its shape may vary. Additionally, in embodiments, in lieu of a solid body 310, an open frame structure may support various discrete food contact and low pressure areas to achieve objects and advantages of the invention. Flexible tubing can be secured within or along frame struts to a distal food contact area/plate to selectively engage and release the food item.

Alternative Embodiments

In embodiments, a processor is programmed to control the conveyer, slicer, and robotic arm to optimize production and efficiency of the target food item. An example of a scheduling module 277 for food preparation steps to optimize food preparation is described in co-pending US Patent Publication No. 20190176338, filed Feb. 20, 2019, and entitled “ROBOTIC SLED-ENHANCED FOOD PREPARATION SYSTEM AND RELATED METHODS.” In embodiments, a means to eject or remove the food item from the gripping device is mechanical based. Examples of mechanical based means include, without limitation, a mechanical piston configured to cause the component or material to release from the gripper device, or vibration-based, in which the assembly is shaken or agitated to cause the material to overcome static friction and viscous liquid forces. A non-limiting example of a vibrating means or vibrator is a motor. Additional examples of agitator type devices for use with robotic arms are described in US Publication No. 20200046168, filed Aug. 7, 2019, and entitled “ROBOTIC KITCHEN ASSISTANT FOR FRYING INCLUDING AGITATOR ASSEMBLY FOR SHAKING UTENSIL”, the entirety of which is incorporated herein by reference.

1. A robotic food singulation system for preparing individual food units from a raw food, the system comprising:
a conveyor system comprising a conveyor belt;
a food preparation device arranged above the conveyor belt and adapted to accept the raw food and output a plurality of food units, one food unit at a time, onto the conveyor belt;
at least one sensor or camera aimed at the conveyor belt;
a robotic arm adapted to pick up the food units, one at a time, from the conveyor and place the food units, one at a time, on a target substrate;
a memory device having stored thereon multiple patterns or arrangements for the food items on a target substrate; and
a processor operable to:
determine the presence of each food unit on the conveyor belt;
determine an identity score for the food unit on the conveyor belt;
evaluate singulation quality of the food item based on a plurality of characteristics of the food unit while on the conveyor belt;
compute a pickup location of the food unit for pickup;
instruct the robotic arm to pick up the food unit; and
instruct the robotic arm to place the food unit on a target substrate according to one of said arrangements or patterns from the memory device.

2. The robotic food singulation system of claim 1, wherein the food preparation device is a slicer, and operable to output individual slices of the raw food.

3. The robotic food singulation system of claim 1, wherein the computed pickup location of the food item is based on belt speed, computed trajectory, and present location of the food item.

4. The robotic food singulation system of claim 1, further comprising a food unit classifier trained using individual food units on a moving conveyor belt, and wherein the identity score is based on output from the classifier.

5. The robotic food singulation system of claim 1, further comprising a food quality module, wherein the processor is operable to evaluate quality of the singulation by computing a score of each food unit, and wherein the score is based on a characteristic of the food unit.

6. The robotic food singulation system of claim 5, wherein the characteristic is selected from the group consisting of quantity and edge continuity.

7. The robotic food singulation system of claim 1, further comprising a jawless gripping assembly secured to the robotic arm to lift and hold the individual food item.

8. The robotic food singulation system of claim 7, wherein the jawless gripping assembly comprises:
a body;
a distal region, the distal region comprising at least one lift port; and
a first fluid flowpath through at least a portion of the body, and to the at least one lift port such that when a gas flows along the first fluid flowpath and exits through the at least one lift port, and a food item is adjacent the distal region, a pressure differential is created across the food item sufficient to lift and hold the food item to the distal region.

9. The robotic food singulation system of claim 8, wherein the body of jawless gripping assembly further comprises a second fluid flowpath through at least a portion of the body, and to at least one release port on the distal region such that when a gas flows along the second fluid flowpath and exits through the at least one release port, and a food item is stuck to the distal region despite the termination of gas flow along the first fluid flowpath, a pressure force is created sufficient to detach the food item from the distal region.

10. The robotic food singulation system of claim 9, further comprising a gas jet module operable to instruct a device to stop flow of gas along the first fluid flow path and to activate gas flow along the second fluid flow path.

11. A jawless gripping assembly for use with a robotic arm to assemble food in a kitchen environment, said jawless gripping assembly comprising:
a body;
a distal region, the distal region comprising:
a first area comprising at least one release port, and
a second area outside the first area on the distal region and comprising at least one lift port;
a first fluid flowpath through at least a portion of the body, and to the at least one lift port in the second area such that when a gas flows along the first fluid flowpath and exits through the at least one lift port, and a food item is adjacent the distal region, a pressure differential is created across the food item sufficient to lift and hold the food item to the distal region; and
a second fluid flowpath through at least a portion of the body, and to the at least one release port of the first area such that when a gas flows along the second fluid flowpath and exits through the at least one release port, and a food item is stuck to the distal region despite termination of gas flow along the first fluid flowpath, a pressure force is created sufficient to detach the food item from the distal region.

12. The jawless gripping assembly of claim 11, wherein the at least one lift port comprises an arcuate-shaped openings, collectively forming an annular or donut shape.

13. The jawless gripping assembly of claim 12, wherein the at least one release port comprises at least 6 release ports.

14. The jawless gripping assembly of claim 13, wherein the plurality of release ports collectively occupy less than 25% of the first area.

15. The jawless gripping assembly of claim 11, wherein the first and second flowpaths are formed through the body by a manufacturing technique selected from machining, 3D printing, casting, and injection molding.

16. The jawless gripping assembly of claim 11, wherein the first area is a cavity in the distal region defined by a perimeter wall.

17. The jawless gripping assembly of claim 11, wherein the body defines a main channel and an exit manifold for the first fluid flow path.

18. The jawless gripping assembly of claim 17, wherein the exit manifold leads to said at least one lift port, and said at least one lift port has an annular arrangement with a bell mouth curvature expanding in the direction of gas flow.

19. A robot automated method for prepping food in a kitchen environment, the method comprising at least the following steps:
detecting each food unit;
determining an identity for the food unit;
evaluating singulation quality of the food item based on a plurality of characteristics of the food unit;
creating a gas pressure differential across the food item to pick up the food unit;
robotically locating the food item above a target substrate and according to a predetermined arrangement; and
depositing the food item on said target substrate according to the predetermined arrangement.

20. The method of claim 19, wherein the depositing step is performed with a gas jet stream.
